(19) United States
(12) Patent Application Publication
(10) Pub. No.: US 2011/0247233 A1
(43) Pub. Date: Oct. 13, 2011

(54) COAL DRYING METHOD AND SYSTEM

(76) Inventors: Richard W. Bland, Beckley, WV (US); Bruce McDaniel, Midlothian, VA (US)

(21) Appl. No.: 13/168,186

(22) Filed: Jun. 24, 2011

Related U.S. Application Data
(63) Continuation-in-part of application No. 12/924,570, filed on Sep. 30, 2010.
(60) Provisional application No. 61/247,688, filed on Oct. 1, 2009.

(51) Int. Cl. F26B 5/16; F26B 13/10; F26B 9/08

(52) U.S. Cl. 34/333; 34/95.1; 34/573

(57) ABSTRACT

The present invention provides a method and system for drying coal using activated alumina. The method and system dries the coal by combining coal with the activated alumina. While in combination, the mixture is agitated to maximize surface contact between the activated alumina and the coal. As the coal contact the activated alumina, the surfactant moisture on the coal is then absorbed by the activated alumina. The activated alumina allow for the water molecules to pass into the sieves, thus being removed from the coal. After a period of agitation, the method and system thereby separates the activated alumina and the coal.

### RELATED APPLICATION

The present application is a continuation-in-part of and claims priority to co-pending patent application Ser. No. 12/924,570 entitled “COAL FINE DRYING METHOD AND SYSTEM” filed Sep. 30, 2010 which claims benefit from U.S. Provisional Patent Application Ser. No. 61/247,688 filed Oct. 1, 2009.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to remove moisture from coal and more specifically to drying coal, coal fines and coal refuse.

### BACKGROUND OF THE INVENTION

In the continued push for cleaner technology trends, a concurrent growth trend is the better utilization of existing resources. A common and abundant energy resource is coal. But, there are various concerns and issues associated with coal that challenge the cost-effectiveness and product maximization in the current industry.

Due to mining and processing operations, processed coal typically has high moisture content. Based on the structure of coal, this moisture content is surface level moisture. The inclusion of too much moisture in coal is problematic from both a cost perspective and a use perspective. Coal is processed into varying sizings, including coal, coal fines and coal refuse.

From a cost perspective, customers pay for coal by weight. Inclusion of high moisture content increases the weight of the coal, thus having to be sold at a lower price. Similarly, coal's use for energy purposes is based on the burning of the coal. The inclusion of excess moisture content reduces the effectiveness of the coal because of energy wasted to evaporate off the moisture. When coal is sold, it typically includes a moisture level rating, where a portion of the price is based on this rating. The lower the moisture content, the greater the expected costs for purchasing coal.

In a typical environment, the coal is sorted by size using known sorting techniques. Then, the coal is segmented, with a lower quality material being separated from the higher quality material by, for example specific gravity in a wet process, the sorted sizes are re-combined and sold based on a corresponding moisture content rating. For coal, greater surface area means higher moisture content because the total moisture in coal is made up largely of surfactant moisture. Therefore, larger coal pieces, by volume, have a lower moisture percentage compared with the same corresponding volume of smaller coal pieces.

Current techniques for drying coal fines utilize heat and/or centrifugal force, drying the pieces of coal that have been separated into different sizes. Current centrifugal drying techniques provide for disposal, wasting, of the smallest coal pieces, also referred to as coal, because based on centrifugal drying techniques, there lacks a known means to centrifugally dry the smallest of the coal as well as a cost-effective incentive to attempt to dry these smallest of the coal. The costs associated with the highest percent of moisture on the finer sized coal are greater than the return achieved by selling this size coal themselves.

Current thermal drying techniques cause the loss and therefore the disposal of a portion of the smallest coal pieces, also referred to as coal, because based on current thermal drying techniques, there lacks a known means to retain these dried smallest coal pieces. Also, the known thermal drying technique requires that, generally, all of the sellable coal, regardless of its size, must be included in the thermal drying process to prevent the creation of a dangerous and hazardous atmosphere in the thermal dryer caused when only fine coal is placed into the thermal dryer. This requires an excess cost to dry this coal.

Coal is sold as a mixture of the various sizes and when sold, the coal is priced based on volume and moisture content. To achieve a low moisture content for pricing purposes, current techniques thus have processing facilities excluding the coal fines from being sold as the high moisture content of the coal negatively effects the overall moisture content of a volume of coal (e.g. tonnage). Therefore, in current techniques, processing facilities simply discard large volumes of coal fines because it is not cost-effective to dry the coal.

Relative to mining coal, no viable solutions have been presented to dry the coal fines to a moisture content that makes them economically saleable or to prevent the loss of the smallest of the fine coal to the waste. The existing techniques of using coal beyond a moisture content of around 12% typically employs blowers and heaters, which require capital intensive investment, require substantial energy use, and creates environmental problems and hazards. These hazards are from both energy use and aerolization of the coal.

As such, there exists an economical need for a method and system for drying coal to reduce the moisture content and to prevent the substantial loss of coal in the drying process. Any reduction in moisture thereby increases the cost-effectiveness of coal processing.

Similarly, problems exist in the discarded run-off of fine coal refuse. This material is discarded and stored in external storage fields. These external storage locations can lead to environmental concerns from run-off and other associated problems.

As such, there exists a need for improved techniques for reducing moisture in coal, and not just limited to coal.

### SUMMARY OF THE INVENTION

The present invention provides a method and system for drying coal, coal fines and fine coal refuse using activated alumina. As described herein, coal refers to coal in all available sizings, including coal above coal fines, e.g. 28 mesh and larger, such as but not limited to 1 millimeter, coal fines, e.g. 28 mesh and smaller, as well as the coal fine refuse. The method and system dries the coal by combining them with the activated alumina. While in combination, the mixture is agitated to maximize surface contact with the activated alumina. The surfactant moisture on the coal is then adsorbed by the activated alumina. After a period of agitation, the method and system thereby separates the activated alumina and the coal.

The method and system may use additional techniques for adjusting the volume of coal and/or activated alumina, as well as or in addition to adjust the agitation time-period to maximize the percentage of moisture removal. The method and system may also dry the activated alumina to remove the extracted moisture and thus re-use the activated alumina for future moisture removal operations. The method and system may also add the coal having the moisture removed therefrom back into a coal pile having coal pieces of varying sizes for sale.

Thereby, the method and system provides the recapture and utilization of coal by allowing for the removal of moisture using activated alumina. The utilization of activated alumina significantly reduces processing inefficiencies found in other processing techniques, as well as being environmentally friendly by eliminating the waste of coal in the existing drying technology.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates one embodiment of a system for drying coal;

FIG. 2 illustrates a flowchart of steps of one embodiment for drying coal;

FIG. 3 illustrates another embodiment of a system for drying coal; and

FIG. 4 illustrates a flowchart of steps of another embodiment for drying coal.

### DETAILED DESCRIPTION

In the following description, reference is made to the accompanying drawings that form a part hereof, and in which is shown by way of illustration specific embodiments in which the invention may be practiced. It is to be understood that other embodiments may be utilized and design changes may be made without departing from the scope of the present invention.

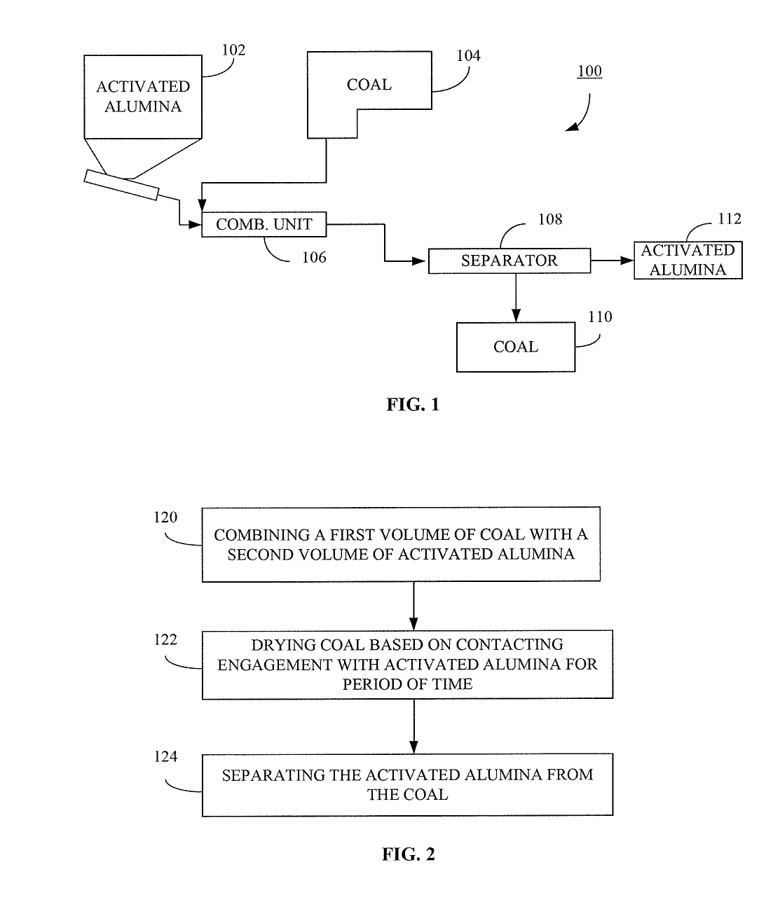

FIG. 1 illustrates one embodiment of a system 100 for drying coal. The system 100 includes an activated alumina distribution unit 102, a coal distribution unit 104, a combination unit 106 and a separator 108. From the separator 108 are dispersed coal 110 and activated alumina 112.

The system 100 operates to remove moisture from coal by having the activated alumina in contacting engagement with the coal. The material science of the activated alumina allow for the absorption and/or absorption of the surfactant moisture on the coal. By facilitating surface area contact between the activated alumina and the coal, the moisture is then transferred out of the coal. Based on sizing differences between the activated alumina and the coal, the coal may be readily separated from the activated alumina. Thereby, once the separation occurs, the remaining coal have a reduced moisture content level. The described techniques overcome the problems associated with the prior techniques of drying coal because it eliminates the need for energy-intensive drying operations and does not generate any airborne particulates common with the heat-based the drying techniques.

The activated alumina distribution unit 102 includes a plurality of activated alumina. It is recognized that molecular sieves may be utilized in alternative embodiments, but structural limitations of the zeolites can dictate unfavorable adjustments of the coal drying process to account for the physical limitations of these beads, such as for example having to reducing the processing speed because of molecular sieve degradation and thus causing increased production costs for the utilization of new sieves.

Co-pending U.S. patent application Ser. No. 12/924,570 describes processing coal fines using varying desiccants, including molecular sieves. These embodiments provide for the removal of surfactant moisture from the coal fines, but improved moisture removal is realized based on the utilization of activated alumina over the molecular sieves. Molecular sieves, are by their very nature, zeolites having a microporous composition whereby water molecules having the associated size are able to fit into the pores of the sieve and the molecules of the corresponding material being dried (e.g. coal) cannot. Activated alumina particles or beads have a hydroxyl surface that attracts and drives material to stick to the surface, compared with molecular sieves that use micropores to allow moisture to pass therethrough. Chemically, compositionally and functionally, activated alumina are different from molecular sieves and provide varying moisture removal capacities. Molecular sieves are exclusionary elements to filter or otherwise selectively reduce a particular chemical element in a mixture based on the manufacturer openings in the sieve itself, such that the functionality and usability of the molecular sieve is dictated by the opening sizes of the pores in the sieves compared with the known adsorption properties of the activated alumina.

Activated alumina is manufactured from aluminium hydroxide by dehydroxylating it in a way that produces a highly porous material; this material can have a surface area significantly over 200 square meters/g. It is made of aluminium oxide (alumina; Al2O3). It has a very high surface-area-to-weight ratio. That means it has a lot of very small pores, almost like tunnels, that run throughout it, and through this composition, the activated alumina allows for the adsorption of moisture. In other embodiments, activated alumina may be selected from any other suitable material(s) recognized by one skilled in the art such that the activated alumina is operative to perform the adsorption or absorption properties described herein, including wherein activated alumina provides for the attraction of moisture molecules to the bead or particle, thus extracting it from the coal.

While the present embodiment is described herein using activated alumina, it is recognized that other types of desiccants can be utilized and employed in the drying of the coal, including for example molecular sieves.

Activated alumina with pores large enough to draw in water molecules, but small enough to prevent any of the coal from entering the particles, can be advantageously employed. Hardened activated alumina also provide the benefit of not breaking down as easily and are readily re-usable once the absorbed water is removed, as described below. In another embodiment, the activated alumina may include magnetic properties for separation from the coal using magnetic forces, if applicable.

A variety of activated alumina can be employed alone or in combination to remove water or moisture from coal as described in further detail below. Hardened activated alumina also provide the benefit of not breaking down as easily and are readily re-usable once the absorbed water is removed, as described below.

In some embodiments activated alumina particles, in the form of beads, are greater than 1, 1.25, 1.5, 1.75, 2.0, 2.25 or 2.5 mm in diameter and less than about 5 mm or 10 mm. When mixed with the wet coal having excess moisture, the activated alumina quickly draw the moisture from the coal. As the particles are larger than the coal (e.g., over a millimeter in diameter), the mixture of sieves and coal can be lightly bounced on a fine mesh grid, where the dry coal can be separated from the activated alumina particles.

The coal distribution unit 104 produces coal. The coal to be dried is generated based on the sorting and separation of extracted coal into various sizes. The coal may be generated from known sorting techniques of sorting the coal into smaller and smaller pieces using any number of a variety of techniques, such as multiple screens wherein coal elements of smaller sizes fall through screens for separation. In one embodiment, the coal may be between the sizes of 1.5 mm to zero, but it is recognized that the coal may be further distinguished in size below size zero or may be further defined into sizings below 1.5 mm, wherein 1.5 mm to zero is an exemplary sizing descriptor, but not as a limiting dimension for the coal utilized herein.

The combination unit 106 may be any number possible devices for combining the activated alumina and coal. The combination unit 106 includes functionality for the contacting engagement of the coal with the activated alumina, plus some degree of agitation. As noted above, the activated alumina operate by removing surfactant moisture, therefore the agitation of the combined mixture of activated alumina and coal increases the surface area contact therebetween.

Additional embodiments of mixers may include internal rotor mixers, continuous mixers, blenders, double arm misers, planetary mixers, ribbon mixers and paddle mixers. Based on the various characteristics of the desiccants and the mineral slurry concentrate, different mixer embodiments provide varying degrees of moisture removal. The various types of mixers allow for customization of the agitation of activated alumina and mineral slurry concentrate for moisture reduction, as well as processing for the re-usability of the activated alumina in the continuous flow process.

Moreover, the removal of surfactant moisture leads to the reduction of inherent moisture in the coal. It is determined that based on the removal of surfactant moisture, inherent moisture is then reduced by further exposure of the coal with the activated alumina. It is estimated that due to the high percent of exposed surface relative to the weight, the fine coal inherent moisture is exposed to the surface, the activated alumina can then remove the now-surfactant moisture by breaking the molecular bond between the water molecules and the carbon molecules.

The separated activated alumina can be a bit dusty and can carry a minute amount of coal with them after they have absorbed the water. Once separated, the activated alumina can be passed to a dryer where they can be dried and sufficient moisture is removed to permit their reuse if desired. Thus, the activated alumina can be employed in a close-loop system, where they are mixed with the coal, and after removing water/moisture (drying) they are separated from the coal and passed through a dryer and reused.

For example, in one embodiment the combination unit 106 may be a circular tube having a circular channel through which the combined mixture of coal and activated alumina pass. This circular tube may be rotated at a particular speed and the tube extended for a particular distance so the coal and activated alumina are engaged for a certain period of time. Typically, the longer the engagement, the more moisture that is removed. As described in further embodiments below, additional feedback can be implemented to adjust the combination unit 106 and thus adjust the moisture level of the coal. In one embodiment, but not a limiting range, the mixing tonnage may have a combination range between 4 parts activated alumina beads to 1 part wet coal to 1 part activated alumina beads to 1 part wet coal, depending on the desired moisture content of the final product.

Another embodiment of the combination unit 106 may be an agitation device or other platform that includes vibration or rotation to cause surface area contact between the coal and the activated alumina. Additional embodiments of the combination unit 106, as recognized by one skilled in the art, may be utilized providing for the above-described functionality of facilitating contacting engagement between the coal and the activated alumina.

Additional embodiments of mixers may include internal rotor mixers, continuous mixers, blenders, double arm misers, planetary mixers, ribbon mixers and paddle mixers. Based on the various characteristics of the desiccants and the mineral slurry concentrate, different mixer embodiments provide varying degrees of moisture removal. The various types of mixers allow for customization of the agitation of activated alumina and mineral slurry concentrate for moisture reduction, as well as processing for the re-usability of the activated alumina in the continuous flow process.

The separator 108 may be any suitable separation device recognized by one skilled in the art. The separator 108 operates using known separator techniques, including for example in one embodiment vibration and vertical displacement. The separator 108 operates by, in one embodiment, providing holes or openings too large that the activated alumina will not pass through, but the coal readily pass therethrough. For example, one embodiment may include a high frequency, low amplitude circular screen for filtering the coal from the activated alumina.

For the sake of brevity, one embodiment of the operations of the system 100 is described relative to the flowchart of FIG. 2. The flowchart of FIG. 2 illustrates the steps of one embodiment of a method for drying coal. The method includes the step, step 120, of combining a first volume of coal with a second volume of activated alumina. With respect to the system 100 of FIG. 1, the activated alumina are dispensed from the activated alumina distribution unit 102 and the coal are dispensed from the coal processing unit 104.

The activated alumina distribution unit 102 releases a predetermined volume of activated alumina beads at a predetermined rate. This volume of beads is in proportion to the volume of coal. Both units 102 and 104 dispense the corresponding elements into the combination unit 106. One embodiment may rely on gravity to facilitate distribution, as well as additional conveyor or transport means may be used to direct the elements from the distribution units 102 and 104 to the combination unit 106. For example, one embodiment may include conveyor belts to move the coal and/or activated alumina into the combination unit 106.

Once the combination unit 106 has the volumes of activated alumina and coal, the next step of the method of FIG. 2 includes drying the coal based on contacting engagement of the activated alumina and the coal. As described above, the activated alumina adsorb surfactant moisture from the coal, where this is facilitated by the agitation of the combination unit 106. In the example of a rotation assembly, the combination unit 106 may include channels through which the combined activated alumina and coal pass, the assembly being rotated at a predetermined speed. The speed and length of the channels controls the time in which the activated alumina and coal are in contact, which directly translates into the corresponding moisture level of the coal after separation.

After the agitation of coal and activated alumina in the combination unit 106, the mixture is passed to the separator 108. In one embodiment, a conveyor belt or any other movement means may be used to pass the mixture to the separator 108. In the methodology of FIG. 2, a next step, 124, is separating the activated alumina from the coal. This step is performed using the separator 108 of FIG. 1. From the separator are split out the coal 110 and the activated alumina 112. In this embodiment, the method of drying coal takes coal from the distribution unit 104, combines them with activated alumina, wherein moisture is then removed, and then the coal are separated from the activated alumina. The remaining product of this drying method are coal 110 having a reduced moisture content level and activated alumina 112 containing the extract moisture.

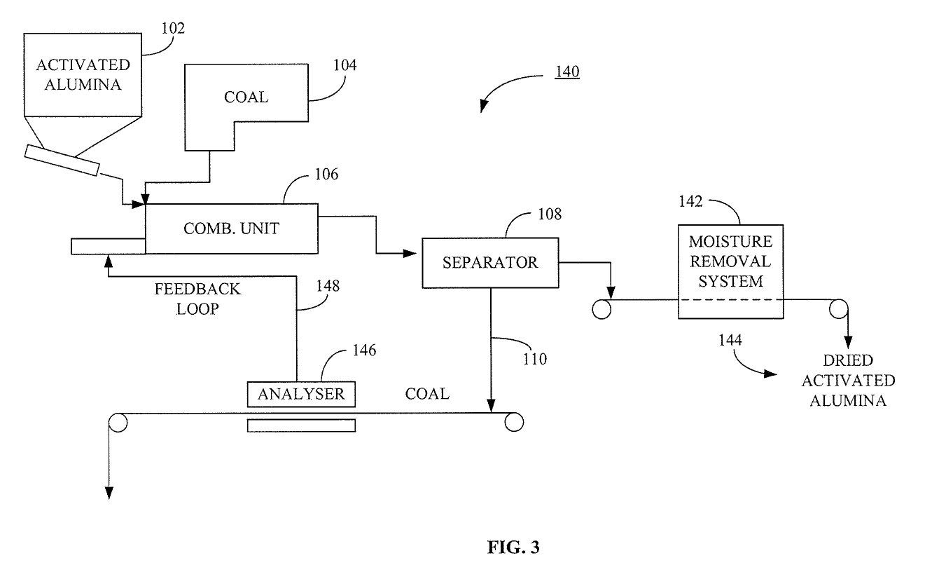

FIG. 3 illustrates another embodiment of a system 140 for drying coal. This system 140 of FIG. 3 includes the elements of the system 100 of FIG. 1, the activated alumina distribution unit 102, the coal processing unit 104, the combination unit 106, the separator 108 and the separated coal 110 and activated alumina 112, in this embodiment in the form of beads. The system 140 further includes a moisture removal system 142 and dried activated alumina 144, as well as a moisture analyzer 146 with a feedback loop 148 to the combination unit 106.

The moisture removal system 142 is a system that operates to remove the moisture from the activated alumina 112. In one embodiment, the system 142 may be a microwave system that uses microwaves to dry the sieves. The imposition of microwaves heats up the sieves and causes the evaporation of the water molecules therefrom. The microwave signal strength and duration are determined based on calculations for removing the moisture and can be based on the volume of activated alumina. For example, the large the volume of activated alumina, the longer the duration of the drying and/or the higher the power of the microwave may be required.

Other embodiments may be utilized for the moisture removal system, wherein other usable systems include operations for removing moisture from the activated alumina. For example, one embodiment may be a heating unit that uses heat to cause the moisture evaporation. Regardless of the specific implementation, the moisture removal system 142 thereby returns the activated alumina to a state similar or identical to their state prior to insertion in the combination unit 106 by causing the moisture to be removed and/or eradicated from therefrom, thus generating the dried activated alumina.

Other embodiments may be utilized for the moisture removal system, wherein other usable systems include operations for removing moisture from the activated alumina. For example, one embodiment may be a heating unit that uses heat to cause the moisture evaporation. Other types of dryers can include direct rotary drying systems, indirect rotary drying systems, catalytic infrared drying systems, bulk drying systems, pressure swing absorption systems, temperature swing absorption systems, aero-flight open chain conveyor drying systems, and, microwave drying systems.

The analyzer 146 is a moisture analyzing device that is operative to determine the moisture level of coal passing therethrough. The analyzer 146 may be any suitable type of moisture analysis device recognized by one skilled in the art, such as but not limited to a product by Sabia Inc. that uses a PGNA elemental analysis combined with their proprietary algorithms to measure real time moisture content of a moving stream of coal on a belt using an integrated analyzer feature contained in their SABIA X1-S Sample Stream Analyzer. SABIA Inc. can also provide their coal blending software CoalFusion to further automate the moisture content measurement process.

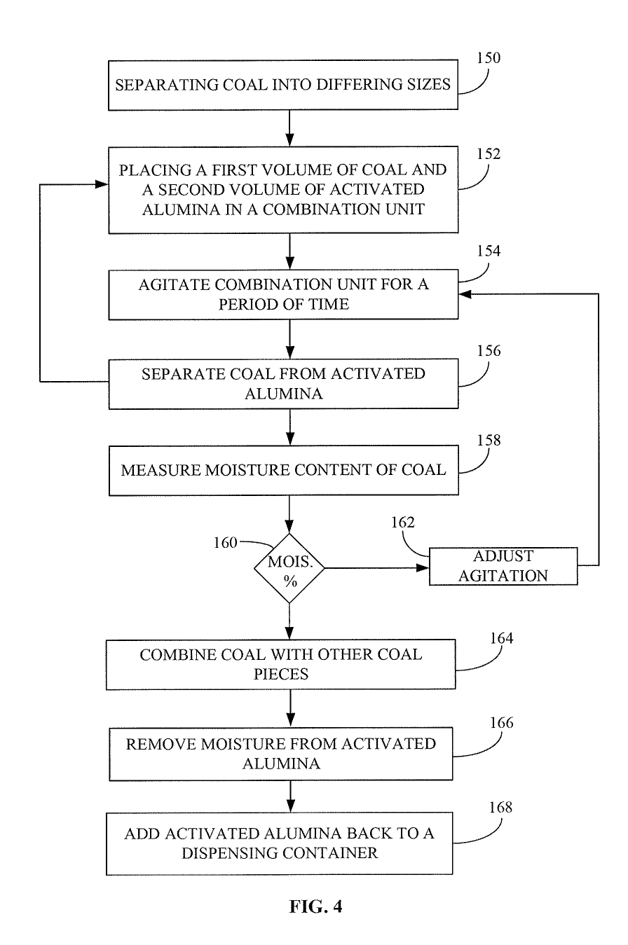

For the sake of brevity, operations of one embodiment of the system 140 are described relative to the flowchart of FIG. 4. FIG. 4 illustrates the steps of one embodiment of drying coal and including additional processing operations for a continuous coal drying process using the activated alumina.

In the methodology of FIG. 4, a first step, step 150 is separating coal into differing sizes including coal. This step may be performed using known separation techniques, separating coal out from larger pieces. For example, the coal may be separated into categories of greater than a quarter inch, quarter inch to 1.5 mm and 1.5 mm to zero. In this embodiment, the coal comprising the coal between 28 mesh to zero are provided to the filter cake distribution unit 104. It is recognized that the coal are not restricted to a sizing of 28 mesh to zero, but rather can be any other suitable sizing, including being further refined into smaller increments, such as 1.5 mm to 28 mesh, 28 mesh to 100 mm, 100 mm to 200 mm, 200 mm to 325 mm and 325 mm to zero, by way of example.

The next steps of the method of FIG. 4 are, step 152, placing a first volume of coal and a second volume of activated alumina in the combination unit, step 154, agitating the combination unit, and step 156, separating the coal from the activated alumina. These steps may be similar to steps 120, 122 and 124 of FIG. 2.

As illustrated in the system 140 of FIG. 3, the separator 108 separates the activated alumina from the coal such that the separate elements may be further processed separately. Step 158 of the methodology includes measuring the moisture content of the coal using the analyzer 146.

Further illustrated in this embodiment, the system 140 is a continuous flow system such that in normal operations, the method of FIG. 4 concurrently reverts to step 152 for the continued placement of coal and activated alumina into the combination unit.

In drying coal, it is not necessary to completely remove all moisture, but rather drying seeks to achieve a target range of moisture content. This moisture content then translates into an overall moisture content per weight, e.g. tonnage, of coal. The sale of coal being based on the moisture content, this embodiment allows for refinement of the coal drying process for coal based on accurate measuring of the moisture content. It is further noted that different types of coal having different drying characteristics, where the different types of coal typically vary based on the region or location where the coal is extracted from the earth, therefore the specific characteristics of the coal itself needs to be taken into account when determining the desired moisture content range for the drying operation using activated alumina.

Step 160 is a decision step to determine if the moisture content is above or below a predetermined moisture level. By way of example and not meant to be a limiting value, the combination unit 106 may seek a moisture level at 9.5 percent within a standard deviation range. If the moisture level is above or below that value, step 162 is to adjust the agitation reverting the process back to step 154. Step 162 represents one possible embodiment for adjusting the moisture level, wherein the system 140 is a continuous flow system such that the feedback loop 148 would adjust the combination unit 106 for current coal drying operations, not the drying of the coal already past the separator 108.

In one embodiment, the combination unit 106 may be a rotational unit including an actuator that controls the rotational speed. Based on the feedback loop 148, this may increase or decrease the speed. For example, if the moisture level is below the desired percentage, this infers that too much moisture is being removed and therefore the amount of contacting engagement between the coal and activated alumina is too long such that the rotational speed is increased. Conversely, if the moisture level is too low, this may indicate the desire to slow down the combination unit 106 to increase the amount of surface engagement time.

Concurrent with the moisture level measurement by the analyzer 146, the method of FIG. 4 includes combining coal with other larger coal pieces, step 164. As described above, the coal are separated out from other larger coal pieces. These other larger coal pieces can be dried using other available less costly means, such as centrifuges, by way of example. For a variety of reasons, complications exist with applying various drying techniques that work with the larger coal pieces to the coal, so the coal are separated and dried separately. In step 164, they are recombined for sale.

In the method of FIG. 4, another step, step 166, is the removal of moisture from the activated alumina. As illustrated in FIG. 3, this may be done using the moisture removal system 142. When the moisture is removed, this generates dried activated alumina 144, which can then be added back to the sieve distribution unit 102. This allows for re-use of the activated alumina for continuous drying operations.

With respect to the feedback loop 148, it is recognized that other modifications may be utilized and the feedback is not expressly limited to the combination unit 106. For example, in one embodiment the activated alumina dispensing unit may include a flow regulator that regulates the volume of activated alumina released into the combination unit 106. The adjustment of the volume of activated alumina may be adjusted to change the moisture level of the coal, such as if there are more activated alumina, it may provide for reducing more moisture and vice versa. In another embodiment, the feedback loop may provide for adjustment of the dispensing rate of coal from the coal distribution device 104.

Thereby, the various embodiments provide methods and systems for drying coal. The drying utilizes activated alumina. Prior uses of activated alumina were related primarily to gas and liquid applications because of the nature of passing molecules between and across the openings in these sieves and therefore was inapplicable to solids, such as to coal. Additionally, prior techniques for drying coal focused significantly on legacy technologies due to the infrastructure costs for building these drying systems, along with known environmental hazards which are currently permitable, as well as costs associated with trying new technologies. Therefore in addition to the inapplicability of activated alumina to solids, the coal processing arts includes an inherent resistance to new technologies for cost and logistical concerns. As described above, the method and system overcome the shortcomings of drying coal with the application of activated alumina in a new technological fashion.

FIGS. 1 through 4 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A method for drying coal comprising:
combining a first volume of coal with a second volume of activated alumina;
drying the coal through contacting engagement of the coal with activated alumina such that moisture content of the coal is reduced by the activated alumina; and
separating the activated alumina from the coal.

2. The method of claim 1 further comprising:
agitating coal and activated alumina when in contacting engagement.

3. The method of claim 1 further comprising:
drying the coal to a first moisture content level.

4. The method of claim 3, wherein the drying of the coal to the first moisture content level includes placing the coal in contact engagement with the activated alumina for a first period of time.

5. The method of claim 1, wherein the coal consists of coal having a sizing of 1 mm or larger.

6. The method of claim 1, wherein the coal consists of coal fines.

7. The method of claim 1, wherein the coal consists of coal fine refuse.

8. A system for drying coal comprising:
a combination unit for holding a first volume of coal and a second volume of activated alumina such that a moisture content of the coal is reduced by the contacting engagement with the activated alumina;
a coal distribution unit for placing the first volume of coal in the combination unit;
a activated alumina distribution unit for placing the second volume of activated alumina in the combination unit; and
a separation device for separating the activated alumina from the coal.

9. The system of claim 8 further comprising:
an agitation device for agitating the combination unit and thereby agitating the coal and activated alumina when in contacting engagement.

10. The system of claim 9 further comprising:
a moisture detection device determining the moisture level of the coal after being in combination with the activated alumina.

11. The system of claim 10 further comprising:
a timing device for timing the contact engagement of the activated alumina and coal to achieve a first moisture level of the coal based on the engagement of the coal and activated alumina.

12. The system of claim 10 further comprising:
a coal volume distribution adjuster for adjusting the first volume of coal in the combination unit such that the coal volume distribution adjuster is adjusted based on the moisture detector.

13. The system of claim 10 further comprising:
an activated alumina volume distribution adjuster for adjusting the second volume of activated alumina in the combination unit such that the activated alumina distribution adjuster is adjusted based on the moisture detector.

14. The system of claim 10 wherein the coal includes at least one of: coal having a sizing of 1 mm or larger; coal fines; and coal fines refuse.

15. A method for drying coal comprising:
separating a plurality of coal to generate larger coal pieces and coal;
placing a first volume of the coal in a combination unit;
adding a second a volume of activated alumina in the combination unit;
agitating the combination unit for a first period of time such that the coal are in contacting engagement with activated alumina, thereby reducing a moisture content of the coal;
separating the activated alumina from the coal; and
removing moisture content from the activated alumina.

16. The method of claim 15 further comprising:
recombining the coal with the larger coal pieces.

17. The method of claim 15, wherein the separating of the activated alumina from the coal uses a screening technique.

18. The method of claim 15, wherein the second volume of activated alumina is drawn from a activated alumina holding device, the method further comprising:
after removing the moisture from the activated alumina, placing the activated alumina in the activated alumina holding device.

19. The method of claim 15 further comprising:
measuring the moisture content of the coal after agitation in the combination unit; and
adjusting the first period of time based on the measured moisture content.

20. The method of claim 15 further comprising:
measuring the moisture content of the coal after agitation in the combination unit; and
adjusting at least one of: the first volume of coal and the second volume of activated alumina in the combination unit based on the measured moisture content.
